(19) United States
(12) Patent Application Publication
(10) Pub. No.: US 2009/0150207 A1
(43) Pub. Date: Jun. 11, 2009

(54) GENERATION AND TRANSMISSION OF AN ADDRESSABLE SPOT GUIDE FOR ALTERNATE CONTENT INSERTION IN MULTICAST WIRELESS TRANSMISSION

(75) Inventors: Xin Feng, Basking Ridge, NJ (US); Srinivasa Dharmaji, Cupertino, CA (US)

Correspondence Address: GLENN PATENT GROUP, 3475 EDISON WAY, SUITE L, MENLO PARK, CA, 94025, US

(73) Assignee: GoldSpot Media, Sunnyvale, CA (US)

(21) Appl. No.: 12/331,316

(22) Filed: Dec. 9, 2008

Related U.S. Application Data
(60) Provisional application No. 61/005,950, filed on Dec. 10, 2007.

(51) Int. Cl. G06Q 40/00; G06Q 10/00

(52) U.S. Cl. 705/8; 705/14

(57) ABSTRACT

An addressable spot-guide (ASG) is the metadata generated from the advertisement (ad) campaign criteria, the schema of the available ad spots and the characteristics of the ad or ads inserted into the ad-spot. The ASG is generated and transferred into the mobile hand-held viewing platform, typically in advance of the content arrival, through any means available. The ASG enables the recognition, filtering, download and storage of ads on the viewing platform of the focused group for which the ad is meant. The ad is inserted into the content stream at the appropriate ad-spot based on the instructions contained in the ASG. As a result of the ASG, individuals in different target groups will view the same content, but different ads that are targeted to their personal characteristics. The ads are prioritized based on importance to the ad campaign.

### CROSS REFERENCE TO RELATED APPLICATIONS

This patent application claims the benefit of U.S. provisional patent application Ser. No. 61/005,950, Generation and Transmission of an Addressable Spot Guide for Alternate Content Insertion in Multicast Wireless Transmission, filed Dec. 10, 2007, the entirety of which is incorporated herein by this reference thereto.

### BACKGROUND OF THE INVENTION

1. Technical Field

This invention relates to transmission and reception of different focused alternate content and advertisements (ads) to target groups for simultaneous viewing during viewing of content on mobile hand-held devices. More particularly, this invention relates to methods for addressable spot-guide (ASG) generation from the ad campaign targets, viewing criteria for the alternate content or advertisements and schema of the available ad-spots for alternate content or advertisement insertion in a transmitted viewing-content stream. Further more specifically it relates to the insertion for simultaneous viewing of different ads for different targeted groups of audience, in a wireless multicast transmission of content stream.

2. Description of the Related Art

The mobile hand-held viewing platform, also referred to as the viewing platform, and that include, but is not limited to, cell phones, personal data assistant (PDA) and other mobile hand-held display devices, has become the individual's content viewing platform of today. This shift from group viewing of content to individual viewing still does not offer the capability of rendering advertisements (ads) to the individuals or focused groups of individuals. For the purpose of this invention the term ads encompasses all alternate content and advertisements. This inability to render ads is due to the relatively low availability of bandwidth for the wireless multicast broadcast for today's content requirements. The current multicast delivery system used to deliver viewing-content to viewing platforms do not easily lend itself to supplying and rendering different groups of ads using this limited bandwidth available. There is intense effort and development to solve this problem, but the current state-of-the-art is that no real solution has been implemented as of yet.

### SUMMARY OF THE INVENTION

In one embodiment, an addressable spot guide (ASG) comprises metadata that is used to identify targeted advertisements for a targeted group of viewing platform users. The ASG contains advertisement (ad) campaign criteria, the schema of the available ad spots in the content stream, and the characteristics of the ads for transmission.

In one embodiment, the ASG is created by a policy engine that takes information from ad schema and group criteria, which is composed of ad categories, third party information, and mobile broadcast operator customer relations management. The ASG is transmitted along with the targeted advertisements to the viewing platform.

The viewing platform downloads the ASG and the targeted advertisements and saves them to a buffer. In one embodiment, the viewing platform downloads the content stream. The viewing platform identifies ad spots within the content stream and inserts the targeted advertisements into the content stream according to the ASG. The viewing platform renders the targeted advertisements and the content stream. As a result, users in different target groups watch the same content, but with different targeted advertisements.

### BRIEF DESCRIPTION OF THE DRAWINGS

FIG. 1 is a block diagram showing addressable spot guide generation and use according to one embodiment of the invention;

FIG. 2 is a block representation of a server system for supplying the information for generating an addressable spot guide according to one embodiment of the invention;

FIG. 3 is a flow diagram representing the steps for inserting a targeted advertisement into a content stream using an addressable spot guide according to one embodiment of the invention; and

FIG. 4 is an example of a viewing platform for receiving and rendering the advertisements and content stream according to one embodiment of the invention.

### DETAILED DESCRIPTION OF THE INVENTION

In one embodiment, the invention comprises a method and/or an apparatus for identifying and filtering focused ads that are associated with a target customer. In one embodiment, the invention includes a means for linking the ad-spots within a content stream to the targeted ads and a means for rendering the ad at the appropriate time when the ad-spot arrives as part of the multicast content stream. This enables the rendering, insertion, and viewing of the correct focused ad by the appropriate target individual within the ad-spot specified.

An ASG is the metadata generated from the ad campaign criteria, the schema of the available ad-spots, and the characteristics of the ad(s) for insertion in the ad-spot. The ASG is generated and transferred into the mobile hand-held viewing platform, typically in advance of the content arrival, through any means available. The ASG enables the recognition, filtering, download and storage of ads on the viewing platform of the focused group for which the ad is meant. The ad is inserted into the content stream at the appropriate ad-spot based on the instructions contained in the ASG. This allows the use of different ads to be simultaneously displayed during the viewing of the same transmitted content on viewing platforms, by individuals in different target groups. It also allows prioritization of the different ads shown based on importance to the ad campaign.

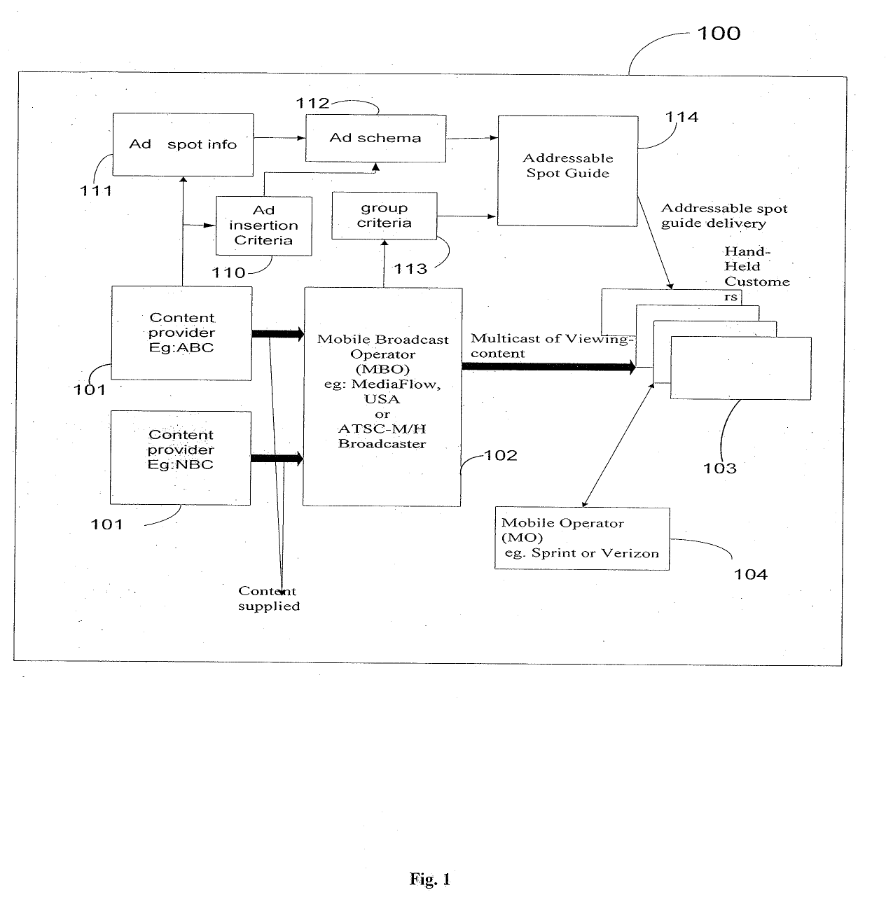

FIG. 1 is an exemplary and non-limiting schematic block diagram 100 of the typical generation and use of an ASG 114 for the disclosed application. The information necessary to create the ASG 114 is made available by the content provider or network 101, e.g. ABC, NBC, etc. and the mobile broadcast operator (MBO) 102, e.g. AT&T, Singular, etc.

The content provider network 101 provides ad insertion criteria 110 and available ad spot information 111, which includes the characteristics of the ad campaign and a variety of information on the available ad-spots, e.g. start, duration etc. The ad spot information 111 is combined with the ad insertion criteria 110 to form the ad schema 112 of the focused ads.

The MBO 102 receives content from the content provider 101 and transmits it to the viewing platform 103. Even though the MBO 102 possesses the content for at least some period of time, the content itself always belongs to the content provider 101. The MBO 102 uses focused group criteria (group criteria) 113 to define the target groups. In one embodiment, the focused group criteria 113 contain identifying characteristics of each focus group, characteristics of each set of focused advertisements to be delivered to the focused group, details of available ad spots to be used for insertion of a focused advertisement from the set of focused advertisements, a priority listing for each of the focused advertisements, and the characteristics of the target group.

The ASG 114 is generated from the ad schema 112 and the group criteria 113. Thus, the ASG 114 is metadata created from a combination of information for generating, supplying, and rendering focused ads to multiple target groups for simultaneous viewing.

In one embodiment, the ASG contains channel information, program identification (ID), timing information, ad POD information, ad ID, and ad priority.

1. Channel information indicates the channel for which the metadata created;

2. The program ID provides information on the program in the channel during which the alternate content is to be displayed;

3. Timing information provides details such as the start time, duration, and end time, etc. of the ad spot within the transmitted content stream. This information is used by a micro-splicer 310 associated with the media player 300 on the viewing platform 103 to insert the proper advertisement into the ad-spot;

4. The ad POD information is the ID for a group of focused ads, i.e. an ad POD generated and associated with a specific target audience;

5. The ad ID identifies the specific ad within the ad POD for insertion at a specific ad spot; and

6. Ad priority indicates the priority sequence for a set of ads for content in the ad POD when multiple spots are addressed.

The ASG 114 is generated and transferred to the viewing platform 103, typically with the ads, or by itself, in advance of the content arrival through any means available, e.g. cable, internet, web, wireless, 3G network, etc. The ASG 114 enables the recognition, filtering, downloading, and storing of ads or an ad group that are specific to a target group onto the viewing platform 103 of that target group. The focused ads for local storage on the viewing platform 103 are downloaded and stored based on the instructions in the ASG 114, through the same set of alternate means as the ASG 114. The mobile operator (MO) 104 owns the viewing platform and is responsible for providing the necessary capability for filtering, download, and storage of the focused ad and the ASG 114.

The metadata in the ASG 114 enables the identification of the correct ad from the group of focused ads for insertion into the right ad-spot during the viewing of the content on the viewing platform 103. The use of ASG 114 also allows prioritization of the different ads shown based on importance to the ad campaign. In one embodiment, the content stream is delivered to the viewing platform 103 via a wireless broadcast content stream. In one embodiment, the broadcast content stream for viewing is transferred by multicast transmission to the viewing platform 103 by the MBO 102.

As a result, the ASG 114 provides a very personal viewing experience for users watching media on the individual viewing platforms 103. The use of the ASG 114 enables ad selection based on use of personal viewing characteristics. It is possible by selective delivery and rendering of different ads to different focused group members to simultaneously enhance the viewing experience and maximize the ad campaign impact. The viewing experience is enhanced by the generation and supply of different focused ads, each based on the interests of a target group viewable at the same available ad spot in a multicast transmission. The focused ads are selected for viewing by the specific target viewing platforms 103 within a target group based on the information contained in the ASG 114.

Co-pending patent application Ser. No. 12/191,070, Targeted Advertisement Transmission and Delivery in a Bandwidth Limited Multicast Wireless System, filed Aug. 13, 2008, assigned to a common assignee, the contents of which are herein incorporated in their entirety by this reference, covers the delivery and rendering details of the focused advertisements to the target groups. A second co-pending patent application Ser. No. 12/191,086, Methods for Grouping, Targeting and Meeting Objectives for an Advertisement Campaign, filed Aug. 13, 2008, assigned to common assignee, the contents of which are herein incorporated in their entirety by this reference, covers the criteria and method for forming target groups.

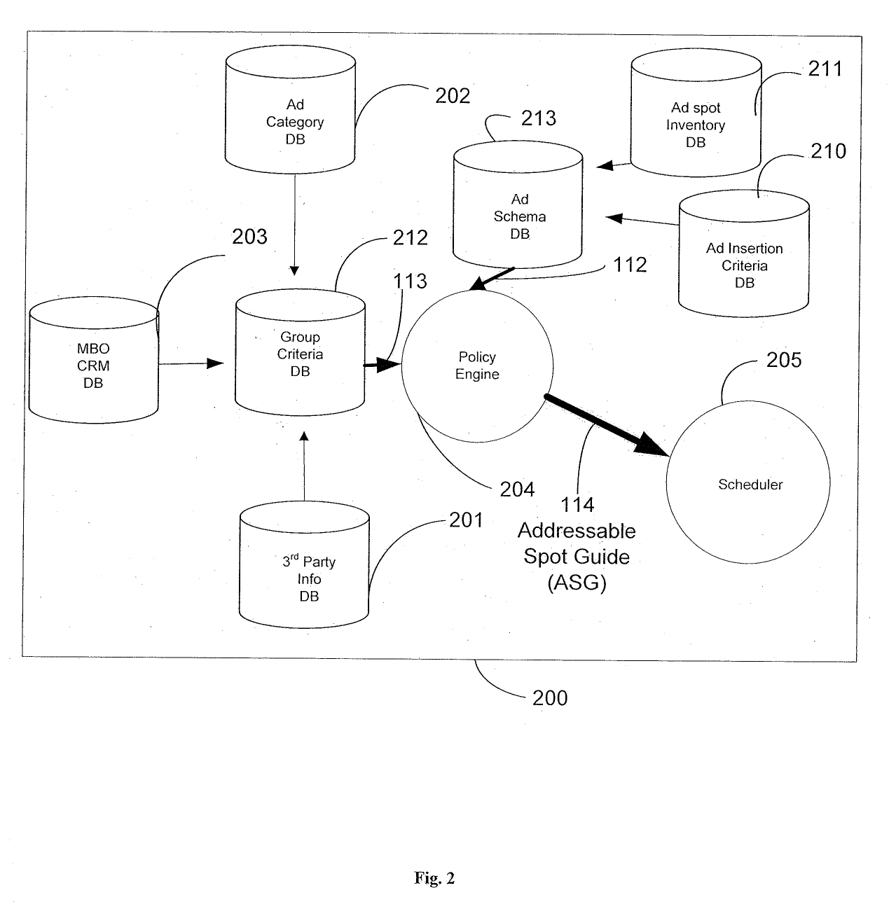

FIG. 2 shows a typical and non-limiting block diagram 200 of a server system for generating an ASG using information from different databases that are associated with the content network 101 and the MBO 102. The ad insertion criteria database 210 supplies the information on the focused ads that are available for rendering on the viewing platform 103 and the ad spot inventory database 211 supplies the information on the available ad spots for compilation and storage in the ad schema database 213. The ad schema is part of the metadata for the ASG 114.

The third party information database 201, the ad category file database 202, and the MBO customer relations management (CRM) database 203 provide the information for the compilation and storage of group criteria 113 for each target group in the group criteria database 212.

In one embodiment, the policy engine 204 includes a server that is used to generate the combined metadata for the ASG 114 from the information available as group criteria 112 and ad schema 113. The databases can be in the same server or independent servers. A scheduler 205 in the server system is responsible for transmitting the ASG 114 and ad files to the viewing platform 103. In one embodiment, the scheduler 205 resides on the viewing platform 103, where it receives and downloads the ASG 114.

The ASG 114, by having all the ad group criteria 113 and ad schema 112 in the viewing platform, enables the viewing platform to identify the ad spots in the content stream. The associated stored ads are inserted into the correct ad spot. The use of the ASG 114 also enables different focused ad groups to be downloaded into different target viewer platform groups. It also allows different focused ads to be displayed with tight synchronization, by each target group in the same ad spot during the viewing of the same wireless multicast content stream.

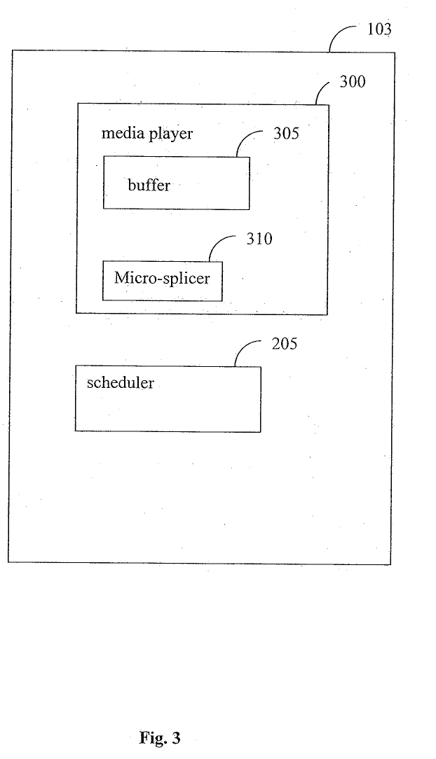

FIG. 3 illustrates one embodiment of a viewing platform 103 for displaying targeted advertisements inserted into the content stream according to one embodiment of the invention. The viewing platform 103 contains a media player 300. The media player 300 stores filtered ads or ad groups in a buffer 305. In another embodiment, the buffer 305 stores content in addition to the ads. In yet another embodiment, the ads and content are stored in separate buffers. The micro-splicer 310 inserts the ads into ad spots in the content stream as indicated by the ASG 114. The micro-splicer 310 works in tandem with the scheduler 205 to ensure that the ads are tightly synchronized with the content, i.e. there are no time gaps between rendering the content and the ads. In one embodiment, the ads are inserted into the ad spot before the content is rendered on the viewing platform 103. In another embodiment, the ad is inserted into the content stream during viewing.

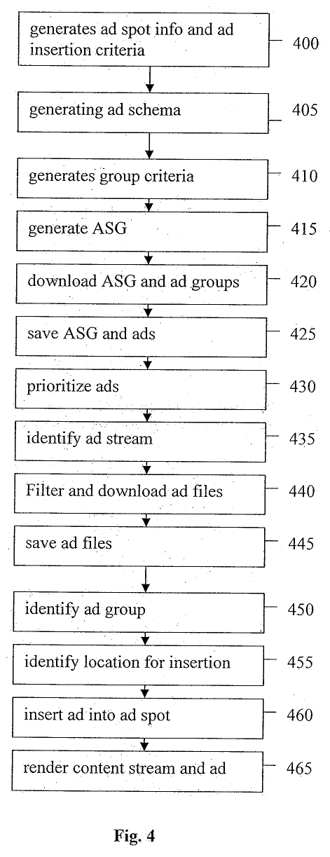

FIG. 4 is a flow diagram illustrating one embodiment for inserting ads into ad spots in the content stream according to the ADS 114. Although these steps are discussed in a particular order, the invention encompasses multiple embodiments. For example, the ads can be downloaded before the content, after the content, or the content is not downloaded at all and streamed instead.

The content provider 101 generates 400 ad spot info 111 and ad insertion criteria 110. An ad schema 112 is generated 405. The MBO 102 generates 410 group criteria 113. The ad schema 112 and group criteria 113 are used to generate 415 the ASG 114.

The viewing platform 103 downloads 420 the ASG 114 and the correct ad groups. The ASG 114 and ad groups are saved 425 to a buffer 305. When the ad group contains multiple ads, the different ads are prioritized 430. The content stream is identified 435. In one embodiment, the content stream is downloaded 440 and saved 445 on the viewing platform 103. The ad group for the channel is identified 450. The scheduler 205 identifies 455 the location for insertion of a specific ad within the content stream, for example, by using the start, duration, and stop of the allowed ad spot. The scheduler ensures that the ad is tightly synchronized with the content stream. The micro-splicer 310 inserts 460 the ad into the ad spot in the content stream. The media player 300 renders 450 the content stream and ad onto a display on the viewing platform 103.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A system for generating and transmitting an addressable spot guide (ASG) to a handheld device viewing platform for insertion of a plurality of targeted advertisements into a content stream, comprising:
an ad schema component for generating an ad schema from an ad spot information and an ad insertion criteria supplied by a content provider, said ad spot information comprising at least one characteristic of an ad campaign;
a group criteria component for generating a group criteria that identifies at least one target group and said plurality of targeted advertisements appropriate for said at least one target group; and
a policy engine for compiling said ad schema and said group criteria into said ASG, said ASG comprising metadata for recognizing, filtering, and downloading said plurality of targeted advertisements onto said handheld device viewing platform for insertion into said content stream.

2. The system of claim 1, wherein said group criteria comprise at least one identifying characteristic for each focused group, at least one characteristic for each advertisement, a priority listing of each advertisement, and at least one characteristic for said at least one target group for said advertisement.

3. The system of claim 1, said ad spot information further comprising at least one of a start, and end, and a duration for each ad spot.

4. The system of claim 1, wherein said ASG comprises at least one of channel information, program identification, timing information, ad pod information, ad identification, an ad priority.

5. The system of claim 1, wherein said ASG and said advertisement are transmitted together.

6. The system of claim 1, wherein said group criteria comprises information received from at least one of an advertisement category database, a customer relations management database, and a third party information database.

7. A system for receiving and rendering a targeted advertisement on a handheld device viewing platform comprising:
a scheduler for receiving and downloading a plurality of targeted advertisements and an addressable spot guide (ASG), said ASG comprising metadata for identifying ad spots in said content stream for insertion of said plurality of targeted advertisements; and
a media player for rendering said plurality of targeted advertisements and a content stream, said media player comprising:
a buffer for storing said plurality of targeted advertisements; and
a micro-splicer for inserting said identified targeted advertisements into said content stream, said micro-splicer working in tandem with said scheduler to tightly synchronize insertion of said identified targeted advertisement with said content stream.

8. The system of claim 7, wherein micro-splicer inserts said targeted advertisement into said ad spot in said content stream while said content stream is rendered by said media player.

9. The system of claim 7, wherein said buffer stores said content stream and said micro-splicer inserts said targeted advertisement is inserted into said ad spot in said content stream before said content stream is rendered.

10. A computer-implemented method of transmitting targeted advertisements to a handheld device viewing platform using an addressable spot guide (ASG), the method comprising:
generating ad spot information and ad insertion criteria using at least one server, said ad spot information comprising at least one characteristic of an ad campaign;
generating ad schema from said ad spot information and said ad insertion criteria using said at least one server;
generating group criteria for identifying at least one target group and a plurality of targeted advertisements appropriate for said at least one target group using said at least one server;
generating an ASG associated with said plurality of targeted advertisements using a policy engine using said at least one server, said policy engine compiling said ad schema and group criteria to form metadata; and
transmitting said ASG and said plurality of targeted advertisements to said handheld device for each user in said at least one target group viewing platform for insertion of said targeted advertisements into a content stream.

11. The method of claim 10, wherein said ad spot information further comprises at least one of a start, an end, and a duration of each ad spot.

12. The method of claim 10, wherein said group criteria comprises information received from at least one of an advertisement category database, a customer relations management database, and a third party information database.

13. The method of claim 10, wherein said ASG comprises information for generating, supplying, and rendering said plurality of targeted advertisements to said handheld device viewing platform.

14. The method of claim 10, wherein said ASG comprises at least one of channel information, program identification, timing information, ad pod information, ad identification, and ad priority.

15. The method of claim 10, wherein said transmitting step is performed by a scheduler.

16. The method of claim 10, wherein said ASG and said plurality of targeted advertisements are transmitted to said handheld device before said content is received by said handheld device.

17. A method of rendering targeted advertisements on a handheld device viewing platform using an addressable spot guide (ASG), the method comprising:
receiving said ASG and a plurality of targeted advertisements on said handheld device viewing platform, said ASG comprising metadata about said targeted advertisements;
storing said ASG and a plurality of targeted advertisements on a buffer;
identifying a content stream;
identifying an ad spot in said content stream;
inserting at least one of said plurality of targeted advertisements into said ad spot in said content stream using a micro-splicer; and
rendering said plurality of advertisements and said content stream on said handheld device viewing platform.

18. The method of claim 17, further comprising the step of prioritizing said plurality of targeted advertisements according to an ad criteria.

19. The method of claim 17, further comprising tightly synchronizing said at least one of said plurality of targeted advertisements with said content stream.

20. The method of claim 17, further comprising the step of downloading said content stream to said handheld device viewing platform.
